(19) United States
(12) Patent Application Publication
(10) Pub. No.: US 2026/0355994 A1
(43) Pub. Date: Nov. 12, 2026

(54) Sheath for Cutting Tool

(71) Applicant: Milwaukee Electric Tool Corporation, Brookfield, WI (US)

(72) Inventor: Ryan M. Antenore, South Milwaukee, WI (US)

(21) Appl. No.: 19/577,972

(22) Filed: Mar. 25, 2026

Related U.S. Application Data
(60) Provisional application No. 63/800,681, filed on May 6, 2025.
(60) Provisional application No. 63/826,120, filed on Jun. 18, 2025.

(51) Int. Cl. B26B 29/02; B23D 49/14; B23D 59/00

(52) U.S. Cl. CPC B26B 29/025; B23D 49/14; B23D 59/00

(57) ABSTRACT

Various embodiments of a saw assembly are provided. The saw assembly includes a saw and a sheath. The saw is removably couplable to the sheath which includes a locking mechanism. In various embodiments, the locking mechanism includes a flexible arm with a roller configured to engage the saw. The locking mechanism resists movement of the saw out of the sheath.

### CROSS-REFERENCE TO RELATED PATENT APPLICATIONS

The present application claims the benefit of and priority to U.S. Provisional Application No. 63/826,120 filed on Jun. 18, 2025, and to U.S. Provisional Application No. 63/800,681 filed on May 6, 2025, which are incorporated herein by reference in their entireties.

### BACKGROUND OF THE INVENTION

The present disclosure is directed generally to cutting tools. The present disclosure relates specifically to a sheath for a toothed cutting tool, such as a saw.

### SUMMARY OF THE INVENTION

One embodiment of the invention relate to a saw assembly. The saw assembly includes a saw and a sheath. The saw includes a handle having a protrusion, an engagement surface positioned on the handle, and a blade extending from the handle. The sheath includes a body extending between a first end and a second end opposite the first end. The sheath further includes a cavity, an opening at the first end of the body a flexible arm, and a rigid projection. The cavity is defined within the body and the opening is connected to the cavity. The flexible arm is positioned at the first end of the body and includes an end that supports a roller. The rigid projection is on the body and the opening is positioned between the rigid projection and the flexible arm. The roller is positioned such that the roller interfaces against the engagement surface of the handle, when the saw is positioned within the sheath. The roller is positioned such that the roller engages the protrusion such that the flexible arm deflects away from the handle, when the saw is being inserted into the cavity.

Another embodiment of the invention relate to a saw assembly. The saw assembly includes a saw and a sheath. The saw includes a handle and a blade extending from the handle. the sheath is removably couplable to the saw. The sheath includes a body extending between a first end and a second end opposite the first end and a cavity defined within the body. The sheath further includes an opening defined at the first end of the body and connected to the cavity, a flexible arm, a roller, and a rigid projection. The flexible arm is positioned on a first side of the opening and extends from the sheath. The roller is supported at a distal end of the flexible arm. The rigid projection is positioned on a second side of the opening that is opposite the first side of the opening.

Another embodiment of the invention relate to a saw assembly. The saw assembly includes a saw and a sheath. The saw includes a handle having a protrusion, a blade extending from the handle and an engagement surface positioned on the handle. The engagement portion is positioned between the engagement surface and the blade along a length of the saw. The sheath is couplable to the saw. The sheath includes a body defining a cavity that is configured to receive the saw and an opening defined at an end of the body, the opening connected to the cavity. The sheath further includes a flexible arm, a roller, and a rigid projection. The flexible arm extends from the sheath. The roller is supported at a distal end of the flexible arm and is configured to interface against the engagement surface. The rigid projection is positioned at the end of the body and extends from the sheath.

Additional features and advantages will be set forth in the detailed description which follows, and, in part, will be readily apparent to those skilled in the art from the description or recognized by practicing the embodiments as described in the written description included, as well as the appended drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 shows a saw system in a disengaged position, according to an exemplary embodiment.

FIG. 2 shows the saw system of FIG. 1 in an engaged position, according to an exemplary embodiment.

FIG. 3 is a perspective view of a saw of the saw system, according to an exemplary embodiment.

FIG. 4 is a left side view of the saw of FIG. 3, according to an exemplary embodiment.

FIG. 5 is a right side view of the saw of FIG. 3, according to an exemplary embodiment.

FIG. 6 is a top view of the saw of FIG. 3, according to an exemplary embodiment.

FIG. 7 is a detailed view of an end of the saw of FIG. 3, according to an exemplary embodiment.

FIG. 8 is a detailed view of a saw system, according to another exemplary embodiment.

FIG. 9 is a front view of a sheath of the saw system of FIG. 1, according to an exemplary embodiment.

FIG. 10 is a front view of the saw system of FIG. 1, according to an exemplary embodiment.

FIG. 11 shows the saw system of FIG. 10 supported on a user, according to an exemplary embodiment.

FIG. 12 is a rear view of the saw system of FIG. 1 supported on a user, according to an exemplary embodiment.

FIG. 13 shows a saw system in an engaged position, according to another exemplary embodiment.

FIG. 14 is an exploded view of the saw system of FIG. 13, according to an exemplary embodiment.

FIG. 15 is a detailed view of the engagement between the saw and sheath of the saw system of FIG. 13, according to an exemplary embodiment.

FIG. 16 shows a saw system in a disengaged position, according to another exemplary embodiment.

FIG. 17 shows the saw system of FIG. 16 in an engaged position, according to an exemplary embodiment.

FIG. 18 is a front view of the sheath of the saw system of FIG. 16, according to an exemplary embodiment.

FIG. 19 is a rear view of the sheath of the saw system of FIG. 16, according to an exemplary embodiment.

FIG. 20 is a top view of the sheath of FIG. 18, according to an exemplary embodiment.

FIG. 21 is a cross-sectional view of the sheath taken along line 21-21 of FIG. 20, according to an exemplary embodiment.

FIG. 22 is a detailed view of a roller guide of a saw sheath, according to an exemplary embodiment.

FIG. 23 is a cross-sectional view of the roller guide taken along line 23-23 of FIG. 22, according to an exemplary embodiment.

FIG. 24 is a rear view of the sheath, according to an exemplary embodiment.

FIG. 25 is a detailed view of a buckle receiver of the sheath, according to an exemplary embodiment.

FIG. 26 is a cross-sectional view of a portion of the buckle receiver taken along line 26-26 of FIG. 24.

### DETAILED DESCRIPTION

Referring generally to the figures, various embodiments of a sheath for a cutting tool, shown as a saw sheath, are provided. In various embodiments, the sheath includes a sheath locking mechanism to establish a locking connection between a sheath and a saw.

In various embodiments, the locking mechanism and in particular the sheath includes a lower single flexible arm shown as a cantilevered arm. The arm supports a roller at a distal end of the arm. The sheath also includes an upper rigid thumb push-off projection. A cutting tool, such as a saw has a handle that defines a firm/rigid protrusion on a lower forward end of the handle. During insertion of the saw into the sheath between the lower arm and the upper projection, the protrusion on the handle abuts the roller, which causes the arm to deflect away from the handle to allow the protrusion to advance beyond the rotating roller. Once the handle is fully seated in the sheath, the engagement between the arm/roller on the sheath and the protrusion on the handle helps releasably restrain the saw and the sheath. In other words, the sheath resists movement of the cutting tool out of the sheath. Applicant believes the sheath design discussed herein provides secure engagement with a cutting tool reducing the likelihood of unwanted sheath removal or detachment which improves user safety.

In one or more embodiments, the cutting tool includes a blade geometry adjacent to the handle to provide improved ease of insertion into the sheath. In one or more embodiments, the cutting tool includes a ramp or angled portion of the blade adjacent to the handle.

In various embodiments, the sheath is configured such that saw may be inserted into the sheath with a force between about 9 lbf and 11 lbf. In various embodiments, the sheath is configured such that the saw can be removed from sheath with a force of between about 4 lbf and 7 lbf. In various embodiments, the sheath is configured to maintain less than 4 lbf of sheath removal force degradation after 5,000 manual insertion and removal cycles. Applicant believes the sheath designs discussed herein provide improved ease of insertion and/or removal, increased durability and is unlikely to cause damage to the cutting tool or saw blade.

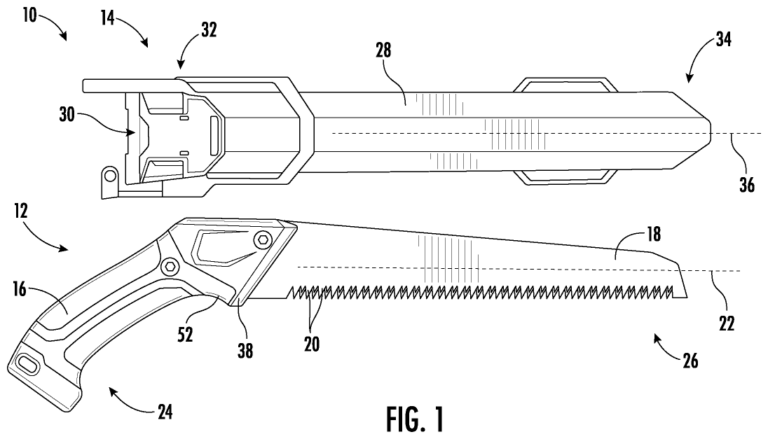

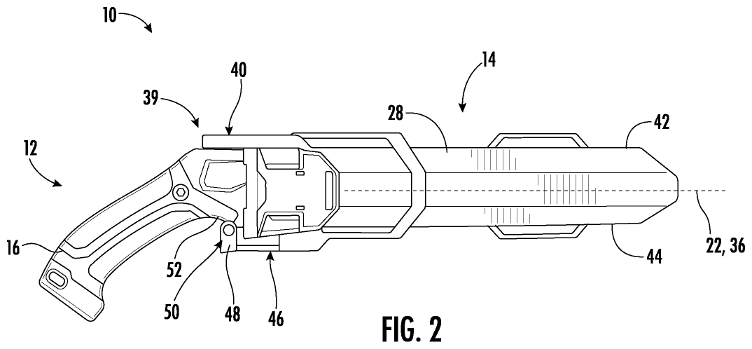

Referring to FIGS. 1-2, details of a cutting tool assembly or saw assembly 10 are shown according to an exemplary embodiment. In various embodiments, saw assembly 10 includes a cutting tool, shown as saw 12 and a removable cover shown as sheath 14. As shown in FIG. 1, saw 12 is disengaged or in an open position relative to sheath 14 while FIG. 2 shows saw 12 in an engaged or covered position.

In various embodiments, saw 12 extends between a gripping end 24 and a cutting end 26. Saw 12 includes a handle 16 and a blade 18. In one or more embodiments, blade 18 extends from handle 16 along a longitudinal axis 22. Saw 12 and in particular blade 18 includes a plurality of teeth 20 along a cutting edge 21 of blade 18. As will be discussed in greater detail below, handle 16 includes an engagement portion or protrusion 38 on a lower forward end of handle 16. Engagement portion 38 extends past or beyond a lower surface of blade 18. The forward end of handle 16 is the portion connected to blade 18. In one or more embodiments, the protrusion 38 is firm or rigid. In one or more embodiments, the handle 16 is formed from a rigid material (e.g., resists deformation).

In various embodiments, the protrusion 38 has a first stiffness and a flexible cantilevered arm 46 has a second stiffness. In various embodiments, the first stiffness is different than the second stiffness. In specific embodiments, the first stiffness is greater than the second stiffness. In other words, the protrusion 38 is more rigid than the flexible arm 46.

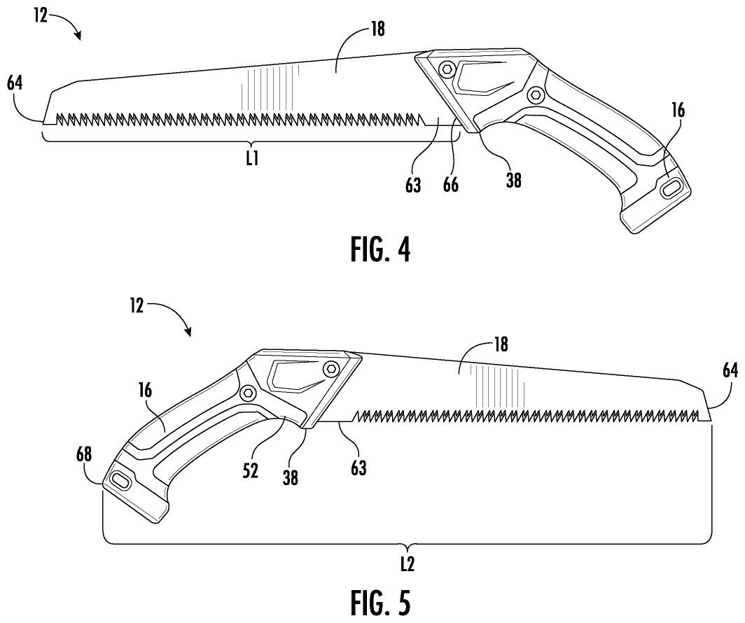

Handle 16 further includes a surface, shown as engagement surface 52 positioned behind protrusion 38. In other words, protrusion 38 is positioned between the blade 18 and engagement surface 52. In various embodiments, protrusion 38 is positioned between the blade 18 and engagement surface 52 along longitudinal axis 22 (see e.g., FIGS. 1 and 5). In various embodiments, surface 52 of handle 16 is a curved surface. In one or more embodiments, surface 52 is a concave surface.

In various embodiments, sheath 14 includes a body 28 that ends between a closed end 34 and an open end 32. Open end 32 includes an opening 30 connected to an internal cavity of sheath 14 that is configured to receive saw 12. Sheath 14 and in particular body 28 of sheath 14 extends along a longitudinal sheath axis 36.

As shown in FIG. 2, when saw 12 is engaged with sheath 14 and/or positioned inside of sheath 14 the longitudinal axis 22 of blade 18 is aligned with longitudinal sheath axis 36. In various embodiments, the sheath 14 includes a sheath locking mechanism 39 to establish a locking or secure connection between sheath 14 and saw 12.

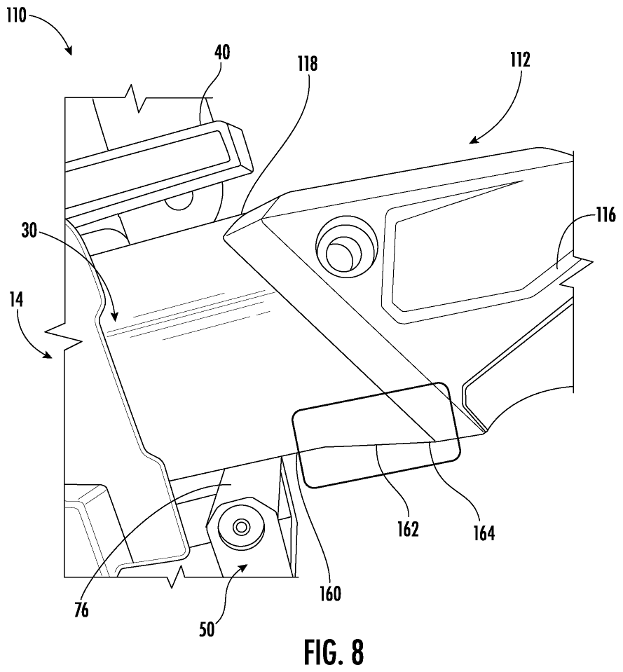

In various embodiments, the locking mechanism 39 and in particular the sheath 14 includes the lower single flexible cantilevered arm 46. The arm 46 supports a roller guide 50 at a distal end 48 of the arm 46. Roller guide 50 supports a roller 76 (see e.g., FIG. 8). When sheath 14 is fully engaged with saw 12 (i.e., saw 12 is entirely seated in sheath 14), roller 76 interfaces against or engages surface 52 such that roller guide 50 is positioned between protrusion 38 and the rest of handle 16. In other words, roller 76 is positioned such that the roller 76 interfaces against engagement surface 52 when saw 12 is positioned within the sheath. In various embodiments, arm 46 is integrally formed with sheath 14.

In various embodiments, the sheath 14 also includes an upper rigid push-off projection 40 positioned along an upper surface 42 of sheath 14. As will generally be understood, a user can use their hand or thumb to push sheath 14 and move sheath 14 relative to saw 12 when the user wants to disengage saw 12 from sheath 14 (i.e., wants to move saw 12 into the open position). In various embodiments, arm 46 is positioned on a first side of opening 30 and projection 40 is positioned on a second side of opening 30 that is opposite the first side.

In various embodiments, the rigid projection 40 has a first stiffness and the flexible cantilevered arm 46 has a second stiffness. In various embodiments, the first stiffness is different than the second stiffness. In specific embodiments, the first stiffness is greater than the second stiffness. In other words, the rigid projection 40 is more rigid than the flexible arm 46.

When a user wants to insert saw 12 into sheath 14, saw is positioned between upper projection 40 and arm 46 while roller 76 abuts protrusion 38. Engagement between roller 76 and protrusion 38 causes arm 46 to deflect away from handle 16 during saw 12 insertion such that the roller guide 50 and roller 76 can move past protrusion 38 and into engagement with surface 52. In other words, roller 76 is positioned such that roller 76 engages the protrusion 38 such that flexible arm 46 deflects away from handle 16 when saw 12 is being inserted into the cavity. Once the handle 16 is fully seated in the sheath 14, the engagement between the arm 46 and/or roller 76 on the sheath 14 and the protrusion 38 on the handle 16 helps releasably restrain the saw 12 and the sheath 14. In other words, when the saw 12 is removed from the sheath 14, the engagement between the roller 76 and protrusion 38 resists movement of the sheath 14 off of saw 12 such that sheath 14 does not accidentally disengage from saw 12.

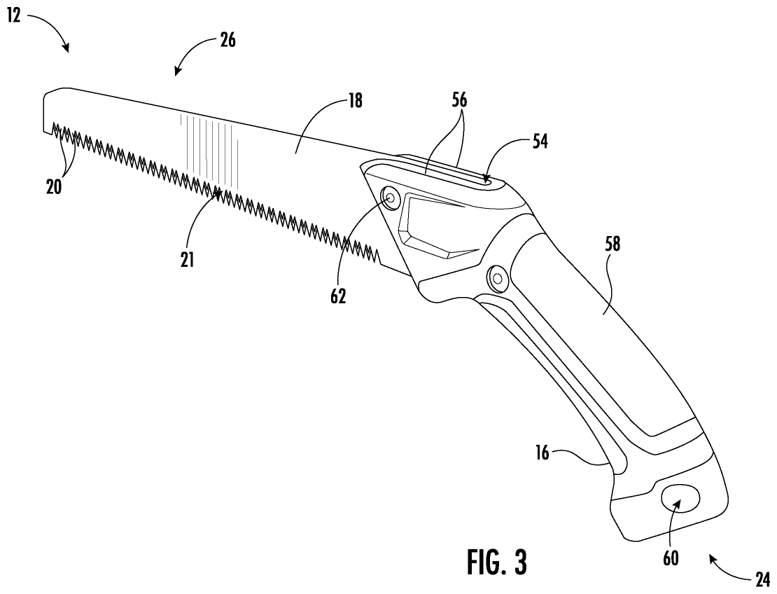

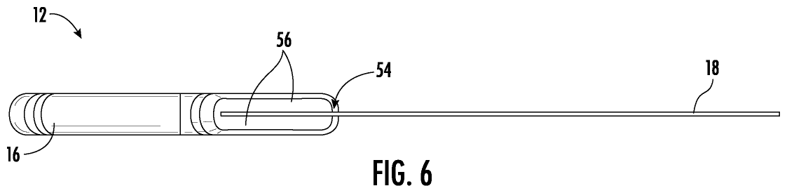

Referring to FIGS. 3-6, details of saw 12 are shown according to an exemplary embodiment. Handle 16 includes a front portion with opposing walls 56 that define a slot 54. Blade 18 of saw 12 is positioned within the slot 54 between the opposing walls 56 and coupled to handle 16 by one or more fasteners 62. In one or more embodiments, handle 16 includes a grip 58. In specific embodiments, grip 58 is an overmolded grip. In various embodiments, handle 16 includes a hole, shown as lanyard hole 60 at gripping end 24. In specific embodiments, lanyard hole 60 is positioned at a rear end 68 of handle 16.

Blade 18 extends between a distal edge 64 and a proximal edge 66 positioned adjacent to handle 16. As will be generally understood, proximal edge 66 is the innermost portion of blade 18 that is not covered by handle 16. In one or more embodiments, blade 18 and specifically cutting edge 21 includes an edge portion 63 without teeth 20. Edge portion 63 is positioned between teeth 20 and protrusion 38 of handle 16. In various embodiments, cutting edge 21 has a length, shown as L1, that extends between distal edge 64 and proximal edge 66. In specific embodiments, L1 is about 10.2 inches. In other embodiments, saw 12 and blade 18 may have different dimensions.

As shown in FIG. 5, saw 12 has a total length L2 defined between rear end 68 of handle 16 and distal edge 64 of blade 18. In specific embodiments, L2 is about 15.85 inches. In other embodiments, saw 12 may have a different length.

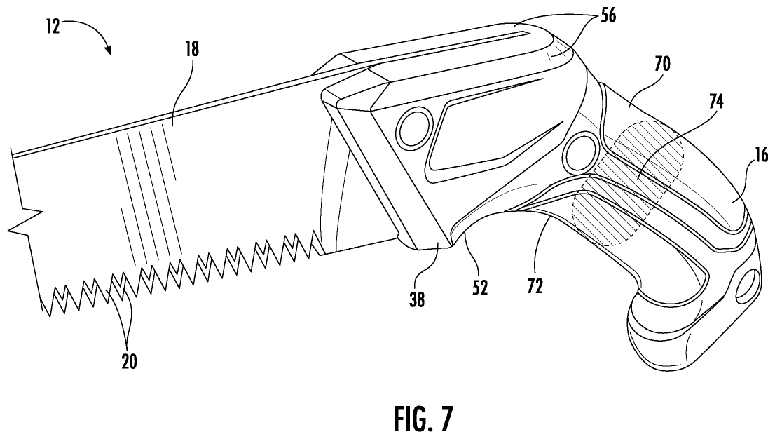

Referring to FIG. 7, details of handle 16 are shown according to an exemplary embodiment. A rear surface 70 of handle 16 opposes a front surface 72 of handle 16. In specific embodiments, both rear surface 70 and front surface 72 are curved. As will generally be understood, curved surfaces 70, 72 allow for the handle 16 to contour to a user's hand. In various embodiments, side surfaces 74 are flat or planar. Applicant believes the flat side surfaces 74 assist a user in keeping the vertical orientation of blade 18 under control.

Referring to FIG. 8, details of a saw 112 that can be utilized with sheath 14 are shown according to an exemplary embodiment. Saw 112 is substantially the same as saw 12 except for the differences discussed herein. Cutting edge 160 (e.g., blade edge with saw teeth) of blade 118 includes an angled portion or ramp 162. Ramp 162 is positioned adjacent to handle 116 and specifically adjacent to proximal edge 164. Proximal edge 164 is the innermost portion of blade 118 that is not covered by handle 116.

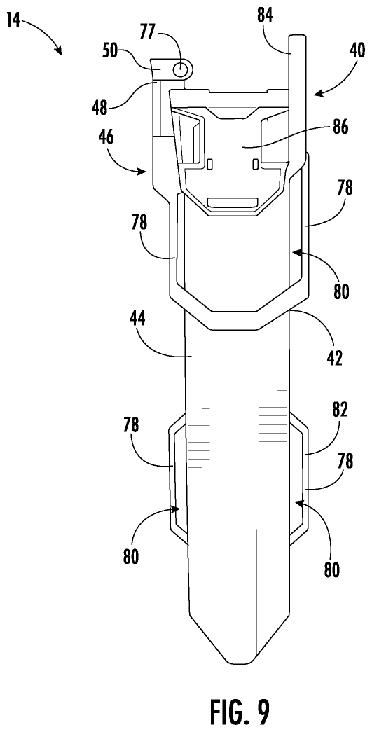

Referring to FIGS. 9-12, details of sheath 14 are shown according to an exemplary embodiment. A pin 77 extends through roller guide 50 to secure roller 76 to arm 46. Body 28 of sheath further includes a lower surface 44 that opposes upper surface 42. One or more loops 78 are positioned along an exterior surface including the lower surface 44 and/or upper surface 42 of sheath 14. Each loop 78 defines an opening 80 between an interior or inward facing surface 82 of the loop 78 and the lower surface 44 or upper surface 42 of sheath 14 respectively. As will be generally understood, inward facing surface 82 of each loop 78 faces toward the longitudinal axis 36 of sheath 14.

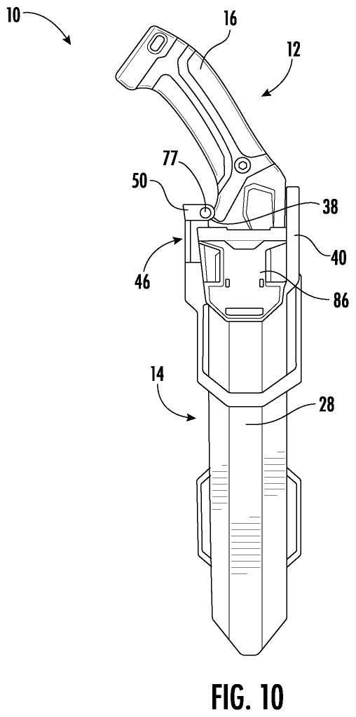

In various embodiments, sheath 14 includes a buckle receiver 86. In specific embodiments, sheath 14 includes a pair of buckle receivers 86 such that each side of body 28 includes a buckle receiver at open end 32 of sheath 14. As shown in FIGS. 9-10, rigid projection 40 includes an inward facing surface 84 that faces toward saw 12 and/or longitudinal axis 36 of sheath 14. In other words, in various embodiments, rigid projection 40 extends along the longitudinal axis 36 of sheath 14. When saw 12 is seated within sheath 14, inward facing surface 84 interfaces against saw 12 and in particular an upper portion of saw 12 that opposes the portion of saw having protrusion 38.

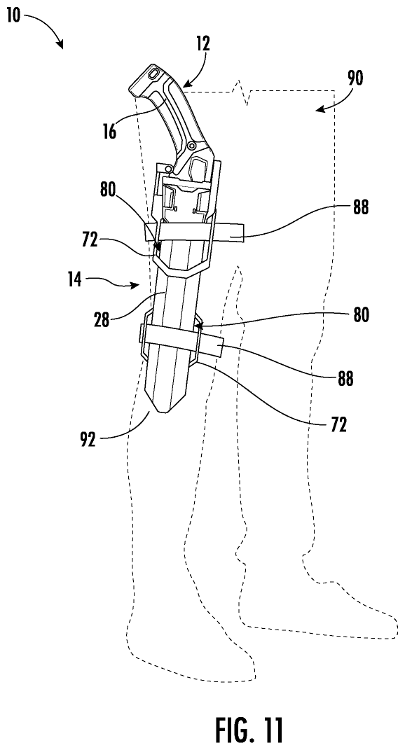

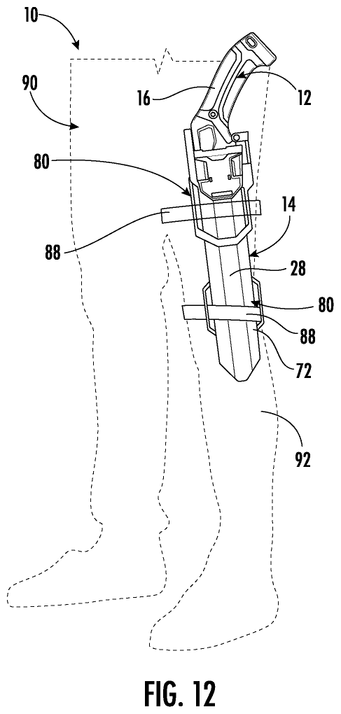

As shown in FIGS. 11-12, loops 78 are configured to receive a strap 88 that can extend through one or more loops 78 to secure sheath 14 to the user or another object. Although sheath 14 is shown strapped to a user's leg, sheath 14 could similarly be strapped and/or coupled to another portion of the user.

In various embodiments, sheath 14 includes four loops 78 with two loops positioned on lower surface 44 and two loops 78 positioned on upper surface 42. In specific embodiments, each loop on lower surface 44 has an opposing loop 78 positioned on upper surface 42 at the same position along the length of the sheath 14.

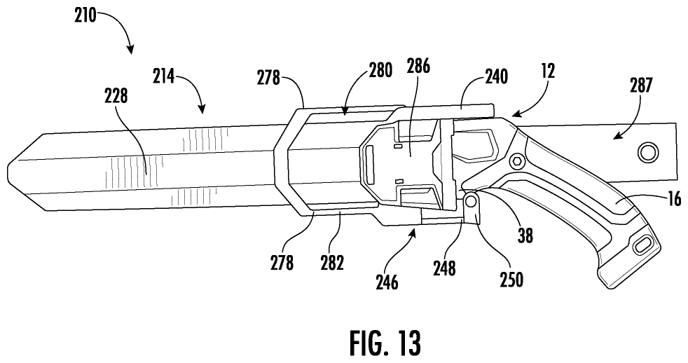

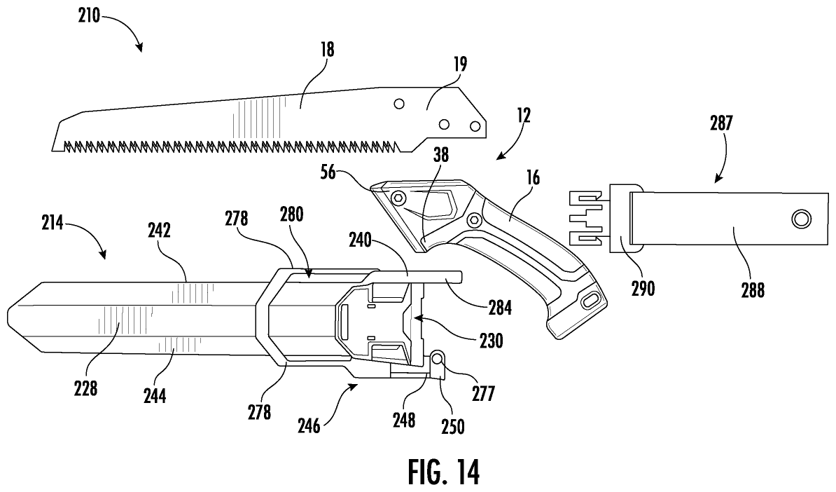

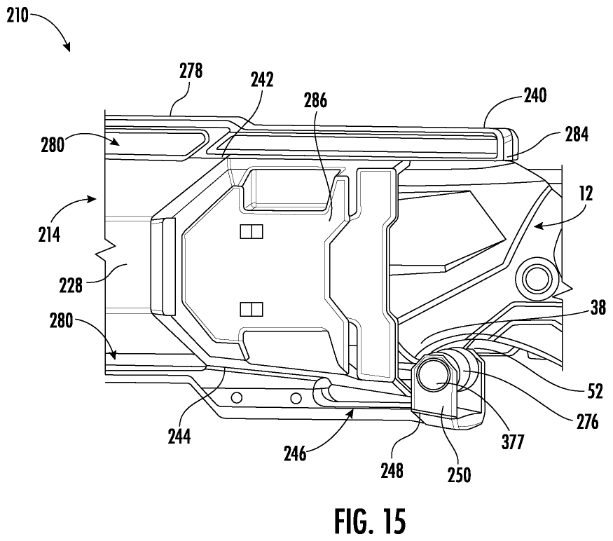

Referring to FIGS. 13-15, details of saw assembly 210 are shown according to an exemplary embodiment. Saw assembly 210 is substantially the same as saw assembly 10 except for the differences discussed herein. In various embodiments, saw assembly 210 includes saw 12 and a removable cover shown as sheath 214.

Sheath 214 is substantially the same as sheath 14 except for the differences discussed herein. Sheath 214 includes a lower single flexible cantilevered arm 246. The arm 246 supports a roller guide 250 at a distal end 248 of the arm 246. Roller guide 250 supports a roller 276. In various embodiments, arm 246 is a separate piece that is couplable to sheath 214. As will be generally understood, arm 246 being a separate component allows for use of a simpler mold to form sheath 214. In various specific embodiment, arm 246 is formed from a high performance plastic material such as polyoxymethylene (POM). In various embodiments, sheath 214 is formed from a first material and the arm 246 is formed from a second material that is different than first material. In various specific embodiments, sheath is formed from a non high performance plastic material while arm 246 is formed from high performance plastic material. As will be generally understood, making arm 246 as a separate component allows for use of different materials that may be better suited to than the material used for the remainder of sheath 214.

In various embodiments, sheath 214 includes a pair of loops 278 that are configured to receive a strap (see e.g., 88). A buckle 287 includes a buckle strap 288 connected to a clip 290. Sheath 214 includes one or more buckle receivers 286 that are configured to engage buckle 287 and receive clip 290.

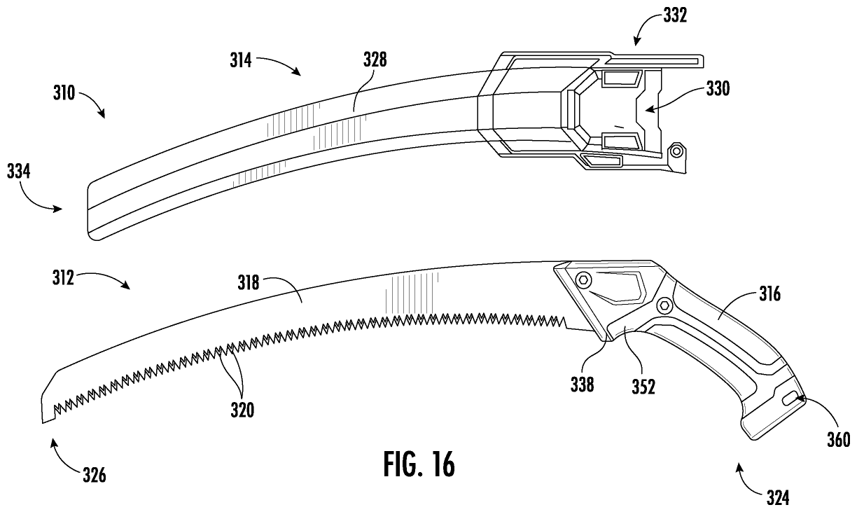

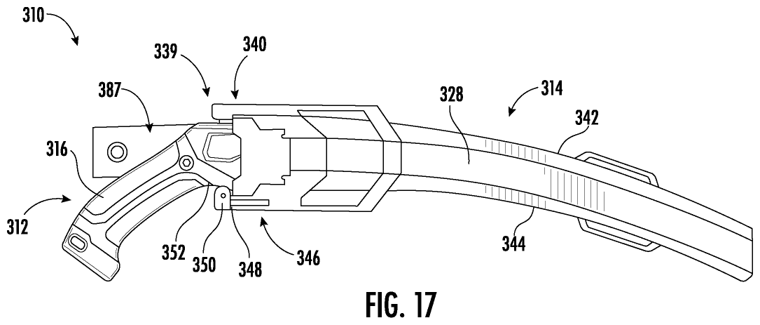

Referring to FIGS. 16-17, details of a cutting tool assembly or saw assembly 310 are shown according to an exemplary embodiment. In various embodiments, saw assembly 310 includes a cutting tool, shown as saw 312 and a removable cover shown as sheath 314. Saw assembly 310 is substantially the same as saw assembly 10, 210 except for the differences discussed herein.

As shown in FIG. 16, saw 312 is disengaged or in an open position relative to sheath 314 while FIG. 17 shows saw 312 in an engaged or covered position. In contrast to saw 12, saw 312 includes a blade 318 that is curved.

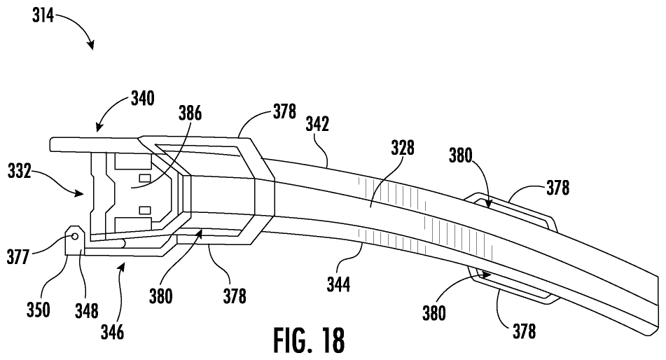

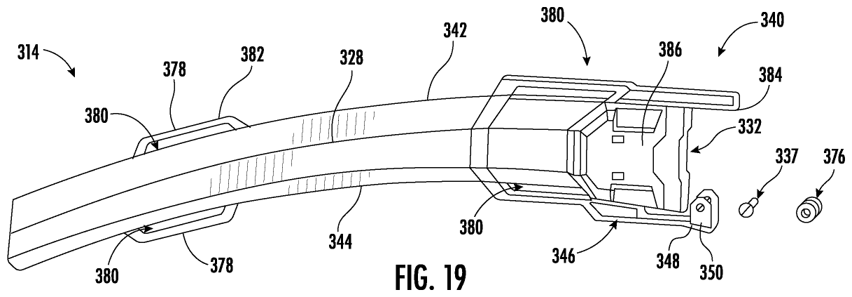

As shown in FIGS. 18-19, sheath 314 includes a locking mechanism 339 that is substantially the same as locking mechanism 39. Locking mechanism 339 includes a lower single flexible cantilevered arm 346. The arm 346 supports a roller guide 350 at a distal end 348 of the arm 346. Roller guide 350 supports a roller 376 that is coupled to guide 350 by a pin 377. When sheath 314 is fully engaged with saw 312 (i.e., saw 312 is entirely seated in sheath 314), roller 376 interfaces against or engages surface 352 such that roller guide 350 is positioned between protrusion 338 and the rest of handle 316.

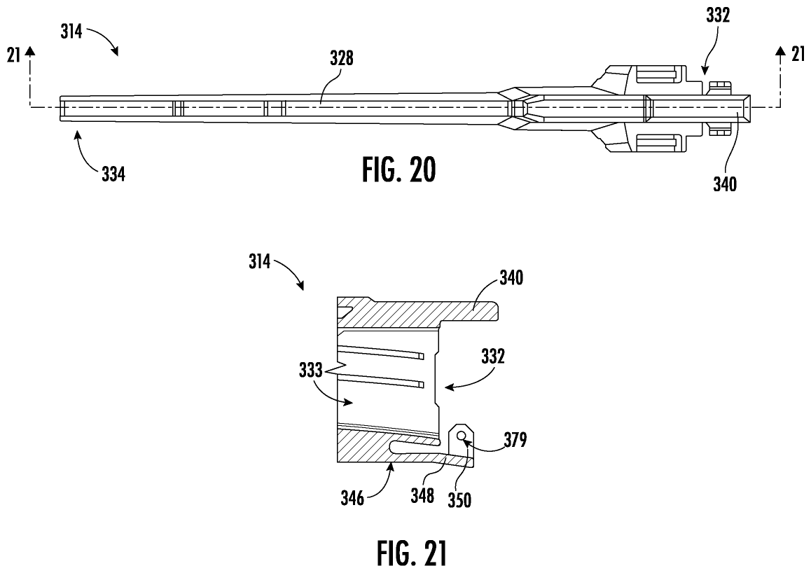

Referring to FIGS. 20-21, FIG. 21 is a cross-sectional view of sheath 314 taken along line 21-21 of FIG. 20. Body 328 of sheath 314 includes an opening 332 connected to an internal cavity shown as channel 333. Opening 332 is positioned between rigid projection 340 and arm 346. Roller guide 350 includes a bore 379 that is configured to receive pin 377.

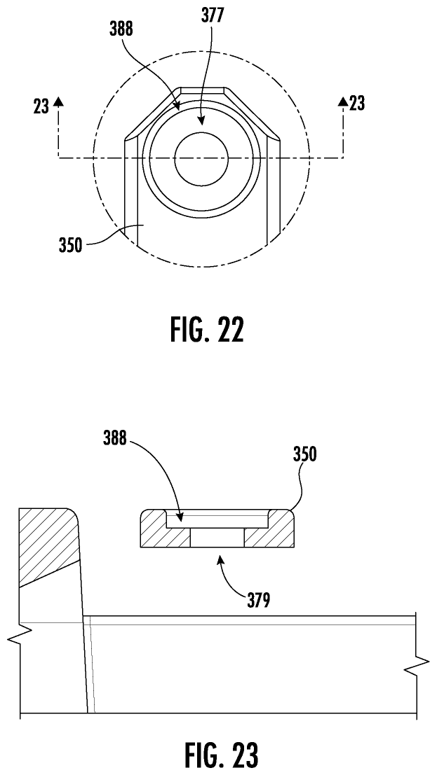

Referring to FIG. 22, details of roller guide 350 are shown according to an exemplary embodiment. Roller guide 350 includes a recess 388 in which pin 377 is received. As shown in the cross-sectional view of FIG. 23, recess 388 is connected to bore 379.

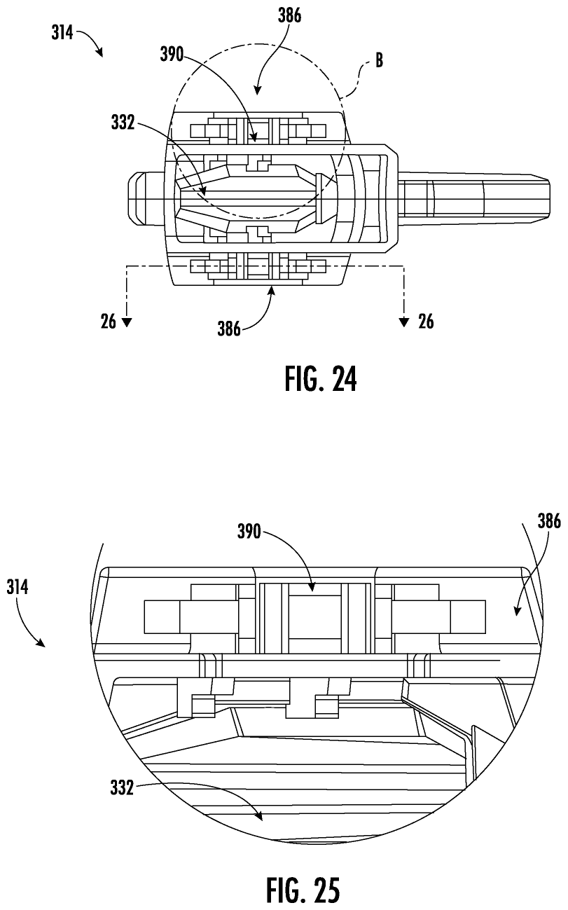

Referring to FIG. 24, details of the open end of sheath 314 are shown, according to an exemplary embodiment. In various embodiments, a buckle receiver 386 is positioned to a side of opening 332 that receives saw 312. In specific embodiments, sheath 314 includes two buckle receivers with a buckle receiver 386 positioned on each side of opening 332. Each buckle receiver 386 includes one or more channels configured to receive a clip of a buckle.

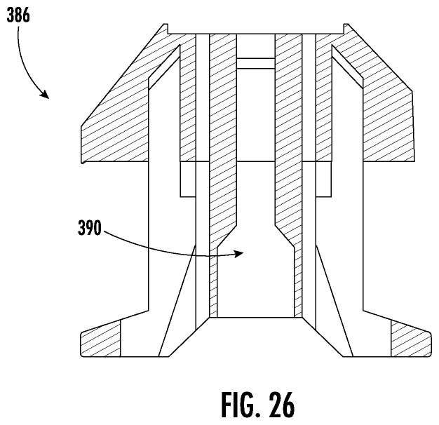

FIG. 25 provides a detailed view of buckle receiver 386. FIG. 26 is a cross-sectional view of a buckle receiver 386 taken along line 26-26 of FIG. 24.

It should be understood that the figures illustrate the exemplary embodiments in detail, and it should be understood that the present application is not limited to the details or methodology set forth in the description or illustrated in the figures. It should also be understood that the terminology is for description purposes only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one. As used herein, “rigidly coupled” refers to two components being coupled in a manner such that the components move together in a fixed positional relationship when acted upon by a force.

Various embodiments of the disclosure relate to any combination of any of the features, and any such combination of features may be claimed in this or future applications. Any of the features, elements or components of any of the exemplary embodiments discussed above may be utilized alone or in combination with any of the features, elements or components of any of the other embodiments discussed above.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A saw assembly comprising:
a saw comprising:
a handle comprising a protrusion;
an engagement surface positioned on the handle; and
a blade extending from the handle; and
a sheath comprising:
a body extending between a first end and a second end opposite the first end;
a cavity defined within the body;
an opening defined at the first end of the body, the opening connected to the cavity;
a flexible arm positioned at the first end of the body, the flexible arm comprising an end that supports a roller; and
a rigid projection on the body, wherein the opening is positioned between the rigid projection and the flexible arm;
wherein the roller is positioned such that the roller interfaces against the engagement surface of the handle, when the saw is positioned within the sheath; and
wherein the roller is positioned such that the roller engages the protrusion such that the flexible arm deflects away from the handle, when the saw is being inserted into the cavity.

2. The saw assembly of claim 1, wherein the protrusion engages the roller to resist movement of the saw relative to the sheath, when the saw is being removed from the cavity.

3. The saw assembly of claim 1, wherein the protrusion of the handle is positioned between the engagement surface and the blade of the saw.

4. The saw assembly of claim 1, wherein the rigid projection has a first stiffness and the flexible arm has a second stiffness, and wherein the first stiffness is different than the second stiffness.

5. The saw assembly of claim 4, wherein the first stiffness is greater than the second stiffness.

6. The saw assembly of claim 1, wherein the handle of the saw is formed from a rigid material.

7. The saw assembly of claim 1, wherein the sheath is configured such that the saw is insertable into the sheath with a force between about 9 lbf and 11 lbf.

8. The saw assembly of claim 1, wherein the sheath is configured such that the saw is removable from the cavity of the sheath with a force of between about 4 lbf and 7 lbf.

9. A saw assembly comprising:
a saw comprising:
a handle; and
a blade extending from the handle;
a sheath removably couplable to the saw, the sheath comprising:
a body extending between a first end and a second end opposite the first end;
a cavity defined within the body;
an opening defined at the first end of the body, the opening connected to the cavity;
a flexible arm positioned on a first side of the opening, the flexible arm extending from the sheath;
a roller supported at a distal end of the flexible arm;
a rigid projection positioned on a second side of the opening that is opposite the first side of the opening.

10. The saw assembly of claim 9, wherein the sheath comprises a longitudinal axis, and wherein the rigid projection extends along the longitudinal axis of the sheath.

11. The saw assembly of claim 9, wherein the sheath further comprises one or more loops positioned along an exterior surface of the sheath, wherein each of the one or more loops defines an opening positioned between an interior surface of the respective loop and the exterior surface of the sheath.

12. The saw assembly of claim 9, wherein the flexible arm is integrally formed with the sheath.

13. The saw assembly of claim 9, wherein the flexible arm is a separate component couplable to the sheath.

14. The saw assembly of claim 9, wherein the sheath is formed from a first material and the flexible arm is formed from a second material, and wherein the first material is different than the second material.

15. The saw assembly of claim 13, wherein the flexible arm is formed from polyoxymethylene.

16. A saw assembly comprising:
a saw comprising:
a handle comprising a engagement portion;
a blade extending from the handle;
an engagement surface positioned on the handle, wherein the engagement portion is positioned between the engagement surface and the blade along a length of the saw;
a sheath couplable to the saw, the sheath comprising:
a body defining a cavity configured to receive the saw;
an opening defined at an end of the body, the opening connected to the cavity;
a flexible arm extending from the sheath;
a roller supported at a distal end of the flexible arm, the roller configured to interface against the engagement surface;
a rigid projection positioned at the end of the body and extending from the sheath.

17. The saw assembly of claim 16, wherein the flexible arm is positioned at the end of the body on a first side of the opening, and wherein the rigid projection is positioned on a second side of the opening opposite from the first side of the opening.

18. The saw assembly of claim 16, wherein the rigid projection includes an inner surface that faces toward the flexible arm.

19. The saw assembly of claim 16, wherein the engagement surface is a concave surface.

20. The saw assembly of claim 16, wherein the engagement portion projects away from the handle in a direction away from the rigid projection when the saw is coupled to the sheath.
